(19) United States
(12) Patent Application Publication
(10) Pub. No.: US 2009/0176183 A1
(43) Pub. Date: Jul. 9, 2009

(54) Lubricious metal orthodontic appliance

(75) Inventors: Timothy L. Conrad, Plymouth, IN (US); Leo P. Rose, SR., Chesterton, IN (US)

Correspondence Address: LLOYD L. ZICKERT;Suite 1100, 79 West Monroe Street, Chicago, IL, 60603, US

(73) Assignee: TP ORTHODONTICS, INC.

(21) Appl. No.: 12/008,374

(22) Filed: Jan. 9, 2008

(51) Int. Cl. A61C 7/20; B05D 3/00; B21F 43/00

(52) U.S. Cl. 433/20; 427/2.29; 29/896.11

(57) ABSTRACT

A metal orthodontic appliance with a polymer coating that becomes slippery when wetted, and a method of making the appliance which comprises cleaning and treating the metal surface of the appliance and coating the appliance with a hydrophilic polymer.

### FIELD OF THE INVENTION

This invention relates in general to metal orthodontic appliances having a lubricious or slippery outer surface when wetted and methods of making the appliances, wherein the appliances are formed of a suitable metal for orthodontic use that is treated before coating with a hydrophilic polymer that is suitably bound to the surface and which when used in the mouth of a patient and wetted will be slippery to facilitate interaction with other appliances during the movement of teeth, and more particularly to metal orthodontic archwires having a hydrophilic polymer matrix coating such that the archwire becomes slippery when wetted as used in a system for treating a patient.

### BACKGROUND OF THE INVENTION

Typically, during orthodontic treatment of a patient, repositioning of teeth involves the use of orthodontic brackets mounted on the teeth and interacting with archwires and ligatures to cause the alignment of the teeth. It is well known that when employing metal, ceramic or plastic appliances having a metal archwire ligated thereto, friction is generated during the sliding of the brackets along the archwire. U.S. Pat. No. 6,203,317 relating to an elastomeric ligature with a hydrophillic polymer coating that is slippery when wetted only addresses the friction between the archwire and the ligature. However, it does not address the friction between the archwire and the archwire slot of the orthodontic bracket. Similarly, self-ligating metal orthodontic brackets that do not use ligatures involve a friction component during the sliding of the brackets along an archwire.

It has also been well known to coat metal orthodontic appliances with plastic resins for purposes of obtaining greater flexibility and increased resiliency, and for aesthetics reasons. This is as disclosed in U.S. Pat. Nos. 4,585,414; 4,659,310; and 4,731,018.

It also has been known to coat metal orthodontic appliances, including brackets and archwires, to resist abrasion and present a tooth-colored appearance, as disclosed in U.S. Pat. No. 4,050,156, which specifically discloses a coating material including a para-oxybenzoyl homopolyester and polytetrafluoroethylene and a pigment for providing a tooth-colored appearance. This patent also suggests reduced friction is attained by the coating. Likewise, U.S. Pat. No. 3,504,438 discloses coating metal orthodontic appliances with a thin film of polytetrafluoroethylene or a material having like properties to produce a surface appearance in both coloration and texture for matching the appearance of adjacent teeth.

It also has been known to apply a hard carbon coating of polycrystalline diamond onto a metal archwire to provide a barrier to nickel and chromium that might otherwise diffuse from an underlying metal substrate. This is as set forth in U.S. Pat. No. 5,288,230.

Prior to the present invention, it has not been known to provide a metal orthodontic appliance having a hydrophilic polymer blend coating that is lubricious or slippery when wetted by conditions that occur within the mouth in order to facilitate the reduction of friction generated during the sliding mechanics of orthodontic appliances employed in treatment of patients for positioning teeth.

### SUMMARY OF THE INVENTION

This invention relates to providing a hydrophilic hydrogel on metal orthodontic appliances and particularly archwires to become slippery when wetted and to enhance the sliding mechanics between the archwire and the orthodontic bracket or brackets during orthodontic treatment. Thus, the hydrophilic hydrogel coating exhibits lubricious properties when in contact with water or saliva in the mouth of a patient. As such, a reduction in the coefficient of friction between the archwire and the archwire slots of orthodontic brackets is obtained to enhance the sliding mechanics of the appliances, all for the purpose of reducing the time of moving teeth during orthodontic treatment.

The invention also relates to a method for coating metal archwires with a hydrophilic hydrogel which includes treating or preparing the archwire to provide an archwire with enhanced receptivity. The treated or prepared archwire then is subjected to a silane treatment, and the silane-treated archwire is coated with a polymer blend that cures into a hydrophilic polymer matrix. One form of coating uses a polymer blend composition that deposits the hydrophilic hydrogel in a matrix comprising polyurethane. A typical hydrophilic hydrogel matrix comprises polyvinyl pyrrolidone and a polyurethane, and this hydrogel coating resists abrasion of the coating or dissolving of the hydrogel coating during use.

As applied to archwires that may be of stainless steel or nickel titanium alloys, the surface of the wire is passivated or otherwise prepared to present a receptive surface and/or be cleaned of contaminants and/or to provide maximum corrosion resistance to the archwire metal. When passivation is practiced, typically a passive oxide film is formed on the wire. For example, contaminants are introduced to the surface of the archwire during processing, and these can be iron particles, ceramic particles, or organic substances. These types of contaminants can impede the corrosion resistance of the metal archwire in the absence of a cleaning and/or passivation treatment.

Following the cleaning and/or passivation treatment of the surface of the metal archwire, the archwire is subjected to a coupling solution treatment, typically with a silane in a suitable manner and thereafter dried. The prepared and silane-treated archwire then is coated with the hydrophilic hydrogel. Thereafter, the coating typically is heat-cured. It will be appreciated that multiple layers of treatment and/or coating material may be applied.

### BRIEF DESCRIPTION OF THE DRAWINGS

FIG. 1 is a plot of friction force versus time for various archwire and ligature combinations on central orthodontic brackets described in Example 3;

FIG. 2 is a plot of friction force versus time for various archwire and ligature combinations on lateral orthodontic brackets described in Example 3;

FIG. 3 is a plot of percent reduction in friction compared to uncoated wire versus time for archwire and ligature combinations on central orthodontic brackets described in Example 3;

FIG. 4 is a plot of percent reduction in friction compared to uncoated wire versus time for archwire and ligature combinations on lateral orthodontic brackets described in Example 3;

FIG. 5 is a plot of peak static friction force versus time for archwires on central brackets described in Example 4;

FIG. 6 is a plot of reduction in friction for archwires on central brackets described in Example 4;

FIG. 7 is a plot of peak static friction force versus time for archwires on lateral brackets described in Example 4;

FIG. 8 is a plot of reduction in friction for archwires on lateral brackets described in Example 4;

FIG. 9 is a plot of reduction in friction versus time for tests with uncoated elastic ligatures and lubricious polymer blend coated archwires used with central orthodontic brackets;

FIG. 10 is a plot of reduction in friction versus time for tests with lubricious coated elastic ligatures and lubricious polymer blend coated archwires used with central orthodontic brackets;

FIG. 11 is a plot of reduction in friction versus time for tests with uncoated elastic ligatures and lubricious polymer blend coated archwires used with lateral orthodontic brackets; and

FIG. 12 is a plot of reduction in friction versus time for tests with lubricious coated elastic ligatures and lubricious polymer blend coated archwires used with lateral orthodontic brackets;

### DESCRIPTION OF THE ILLUSTRATED EMBODIMENTS

As required, detailed embodiments of the present invention are disclosed herein; however, it is to be understood that the disclosed embodiments are merely exemplary of the invention, which may be embodied in various forms. Therefore, specific details disclosed herein are not to be interpreted as limiting, but merely as a basis for the claims and as a representative basis for teaching one skilled in the art to variously employ the present invention in virtually any appropriate manner.

Orthodontic treatment typically includes the use of curved archwires that are placed within an archwire slot of an orthodontic bracket that engages a tooth or teeth for orthodontic treatment. Typically, an archwire engages a plurality of orthodontic brackets during an orthodontic procedure. The present invention relates to enhancing lubricity or reducing friction between the archwire and the orthodontic bracket, more typically the archwire slot or slots of the orthodontic bracket or brackets. It will be appreciated that friction between the archwire and buccal tubes will also be reduced. When the teeth being subjected to orthodontic treatment are in a misaligned position, the orthodontist installs the system so that the archwires are bent elastically and apply a force against the bracket. This force causes the tooth to which the bracket is attached or otherwise engaged to move to the desired position targeted during the orthodontic procedure.

Friction exerted on the archwire is in the form of the static friction on the archwire. Static friction is the friction that must be overcome to begin movement, while kinetic friction is the friction that occurs while something is moving. Typically the static friction is greater than the kinetic friction. Tooth movement is a series of minute start and stop movements of the tooth. In order to lower friction force associated with tooth movement one must therefore find a way to lower the static friction. The coating approach of the present disclosure successfully overcomes the static friction threshold.

The present archwires successfully address the problem of friction between the orthodontic archwire and the bracket or brackets, the archwires having a friction-reducing coating that exhibits lubricious properties when in contact with water or saliva in the mouth of the patient. These coated orthodontic archwires exhibit a reduction in the coefficient of friction between the orthodontic archwire and the orthodontic brackets and/or archwire slots of the brackets. The coating positions a hydrophilic hydrogel onto a metal archwire in a manner such that the hydrophilic hydrogel is especially adherent to the metal wire and resistant to abrasion. The hydrophilic hydrogel exhibits the property of exhibiting increased lubricity when in contact with solutions containing water, such as those encountered when the orthodontic appliance is positioned within the mouth of a patient.

The archwire itself prior to treatment is a metal wire that typically is circular in cross-section along some or all of its length. However, it should be appreciated the archwire may be rectangular in cross section. Typical orthodontic archwire metals are alloys of multiple metals, specifically including stainless steel, nickel titanium alloys, including so-called shape-memory nickel titanium alloys and other alloys safe for use in the mouth and that exhibit adequate strength and bendability attributes. An example of a stainless steel suitable for orthodontic archwire use is AISI 304 stainless steel. Nickel titanium alloys are generally known in the art and can but need not exhibit superelasticity and/or shape-memory transition characteristics, such as between a martensitic state and an austenitic state. For example, shape-memory nitinol materials can be heat treated into any variety of desired shapes, such as to exhibit a proper arch for use within a specific patient.

A hydrophilic coating is securely applied to the metal archwire to substantially increase lubricity without increasing the thickness of the archwire. The lubricious coating adheres a hydrophilic hydrogel to the metal archwire in a manner that resists dissolving and/or abrasion of the coating off of the metal archwire. This hydrophilic coating is especially lubricious or slippery when wetted according to conditions normally encountered during use of an orthodontic application.

In an illustrated embodiment, a multiple-step procedure is used to form the lubricious and abrasion-resistant coating onto the metal archwire. In summary, a prepared archwire is placed in a silane solution for treatment, followed by rinsing and curing and application of a solution having a hydrophilic hydrogel component that is adhered in a manner that is secure yet exposes the hydrophilic hydrogel to wetting conditions for imparting enhanced lubricity to the thus coated archwire.

More particularly, metal archwires are produced by an approach that typically begins with preparing the metal wire that will be the structural component of the archwire. The approach of specific embodiments herein includes passivation of the wire, followed by rinsing in distilled water and drying. Other approaches include sandblasting of the wire prior to the passivation treatment. Also, electropolishing can be practiced in conjunction with or instead of passivation.

Passivation cleans the surface of the wire of contaminants and restores maximum corrosion resistance to the passive oxide film on the wire. Often contaminants are introduced to the surface of a wire during processing. The surface particles can be iron particles, ceramic particles or organic substances that can impede the corrosion resistance of the wire and device prepared therefrom. By removing contaminants from the surface, the protective oxide coating on the metal can reform in the areas of the contaminant, increasing the corrosion resistance of the metal. Passivation typically refers to this process of the oxide coating being formed, with the oxide being formed by reaction of the metal with oxygen. Also, a silane has a higher bonding strength to the oxide than to the bare metal.

In the typical approach, the metal wire will be immersed in a passivation bath of nitric acid. An exemplary passivation bath comprises from about 60% to about 80% HNO₃ to which water, typically de-ionized water, is slowly added to form a passivation or cleaning solution of about 25 to about 35 volume percent nitric acid. The archwires being prepared usually all remain in the passivation bath solution for between about 25 and about 35 minutes. After removal from the passivation bath or completion of other preparation approach, the thus prepared wires are rinsed, typically in water, and dried. If desired, drying can be facilitated by placing in an oven at a temperature of between about 140 to 160° C. for about ten minutes.

The thus prepared wires then are subjected to coupling agent treatment. A typical coupling agent comprises a silane solution. A typical silane solution incorporates a coupling agent of N-[3-(trimethoxysilyl)propyl]-N′-4-(vinylbenzyl)ethylene diamine.Cl. A coupling agent such as this usually is present at levels of between about 0.5 and about 40 weight percent of the treatment composition. The silane coupling solution may include up to about 5 weight percent water, the remainder being a solvent or solvents. Examples of suitable solvents include alcohols, ketones and ethers, with alcohols typically being short-chained such as methanol, ethanol and propanol. Mixtures of such solvents also are possible. When water is added to the coupling solution and the coupling agent contains hydrolyzable functional groups, the functional groups can be hydrolyzed to form silanol groups. A typical silane coupling solution comprises between about 0.5 and about 5.0 weight percent of the coupling agent, up to about 3 weight percent water, the remainder being solvent.

Whatever coupling solution is used, same can be applied in any acceptable manner such as dip coating, spray coating, brush coating, submersion, and the like. Once the coupling solution is applied, the coated wire is placed in an oven for drying. When the coupling solution is of the silane type, the drying also includes pryolysis of the silane. Typical oven temperatures can be between about 125 and about 500° C. The higher temperatures typically will require less drying time, and care should be taken to avoid subjecting the wire to elevated temperatures for extended times such that the metal experiences heat treatment conditions. A typical drying time is between about 5 and about 60 minutes, more typically between about 10 and about 30 minutes. This drying may be performed in an oven with an air atmosphere or an oxidizing atmosphere. When desired, multiple treatments with the coupling solution can be performed so as to provide multiple layers of the coupling agent which can improve adhesion of the lubricious coating.

The wires bearing the coupling agent thereafter are coated with the lubricious agent. A composition comprising the lubricious agent in a solvent is applied to the pre-treated wires, typically by immersion. The lubricious composition provides a hydrophilic hydrogel that becomes slippery when wet. Archwires coated in the manner described herein exhibit lubricious behavior when wet, which in turn causes a reduction in the co-efficient of friction exhibited by the archwire. It is especially desirable that the lubricious agent be a component of and/or be cured within a polymer matrix to enhance adhesion while affording exposure of the lubricious agent or hydrophilic hydrogel so that same is accessible at the surface and is readily wetted. In a sense, the hydrophilic hydrogel polymer is trapped in the polymer matrix of which it may be a component.

A typical coating solution comprises between about 0.5 and about 3 weight percent hydrophilic hydrogel, usually between about 0.8 and about 2.7 weight percent, together with between about 0.4 and about 2 weight percent of another polymer which may be referred to as the matrix polymer, along with between about 6 and about 10 weight percent of a cosolvent for the hydrophilic hydrogel, with the remainder being a solvent or a mixture of solvents. The lubricious coating composition can be considered a polymer blend of the hydrogel and matrix polymers, and the composition has a solvent or solvent blend that should include a good solvent for the polymer matrix, and the solvent or solvent mixture may include an alcohol to decrease viscosity of the coating solution, as well as act as a solvent for the hydrophilic hydrogel.

Depending upon the properties desired for the coated archwire, colorants may be added to the coating solution to impart color to the coated archwire. Anti-microbial components also may be added, such as colloidal silver. When desired, the coating solution may also contain one or more of a biocide, a bio-effecting agent and/or a therapeutic agent. Besides immersion, the coating may be applied by any acceptable manner such as dip coating, spray coating or brush coating.

With more particular reference to the polymer referred to herein as the hydrophilic hydrogel, an especially suitable hydrogel is polyvinyl pyrrolidone (or PVP). PVP has been found to be especially suitable in or as a component of a matrix environment and has excellent lubricious properties when wetted. The polymer for forming the matrix is a thermoplastic polymer. Polyurethanes are especially suitable components of the polymer blend for matrix formation with respect to a PVP type of material such that the PVP might be considered to be held by or trapped in the matrix including the polyurethane.

Polyurethanes exhibiting an ether backbone can be especially advantageous. These so-called polyether urethanes typically are less common than so-called polyester urethanes which exhibit an ester backbone. Polyether polyurethanes typically exhibit a relatively low Shore hardness, such as between about 65 A and about 95 A Shore, for example on the order of about 80 A Shore. Polyether polyurethanes are made from a charge of a polyisocyanate, a polyoxytetramethylene glycol and a polyol which can be a combination of a low molecular weight diol and a higher molecular weight diol such as a polyether diol, including polyoxyethylene glycol, polyoxypropylene glycol and polyoxytetramethylene glycol. Polyether polyurethanes are block co-polymers having a soft segment composed mainly of a higher molecular weight diol and a hard segment composed mainly of the polyisocyanate and a lower molecular weight diol. Such a structure results in a typical polyether polyurethane that exhibits rubber-like elasticity.

A typical co-solvent for PVP is 1-methyl-2-pyrrolidone (or NMP}. Examples of solvents for the coating solution include tetrahydrofuran, methyl ketone, ethyl ketone, ethyl lactate, lower molecular weight alcohols, and mixtures thereof. Typical low molecular weight alcohol solvents are methanol, ethanol and propanol. The composition of solvent and co-solvent should provide a system that includes a good solvent for the polymers of the blend, that is a good solvent for the hydrophilic hydrogel and a good solvent for the matrix-forming polymer, as well as for viscocity reduction.

Exemplary lubricious compositions comprise hydrophilic hydrogel such as PVP in an amount between about 0.5 and about 3.0 weight percent, typically between about 0.7 and 2.8 weight percent, more typically between about 1.0 and about 2.7 weight percent, based on the total weight of the composition. The lubricious composition further comprises a matrix polymer urethane such as a polyether urethane in an amount between about 0.25 and about 3.0 weight percent, typically between about 0.3 and about 2.5 weight percent, more typically between about 0.4 and about 2.0 weight percent, based on the total weight of the composition. The lubricious composition further comprises solvent material. Typical is a combination of NMP co-solvent at between about 6 to about 10 weight percent, balance other solvent, all based on the total weight of the composition. Such other solvents typically make up at least about 80 weight percent of the composition, typically between about 85 weight percent and about 95 weight percent of the composition. When multiple solvents are used, such as THF and ethanol, they can be in approximately equal amounts.

After coating the wire with the hydrophilic hydrogel and matrix-forming coating solution, curing into the matrix takes place. Typical curing is within an oven at a temperature and time adequate to cure the polymers and to evaporate the solvent or solvents. Such oven temperature is between about 100 and about 300° C., more typically between about 125 and about 175° C. The time in the oven will be between about 10 and about 60 minutes, typically between 25 and about 35 minutes. If desired, multiple layers of the hydrophilic hydrogel coating may be applied to the wire by essentially repeating the coating process.

Orthodontic archwires prepared according to the metal preparation, silane treatment and hydrophilic hydrogel “lubricious-when-wet” coating approach described herein have been found to not significantly affect the mechanical properties of the wire. Nor does this approach significantly increase the dimensions of the wire. This approach has been found to substantially reduce the frictional force required for movement with respect to orthodontic brackets. Friction reduction has been shown to be on the order of about 75% and above when compared with conventional uncoated archwires. Lubricity provided by the coating has abrasion resistance and is maintained through several weeks of use, typically on the order of eight weeks of use.

Referring particularly to the effect of the coating procedure described herein on the dimensions of the archwire, measurement according to industry standards has shown no perceptible change in diameter due to the treatment and coating. For example, when measured according to ANSI/ADA Specification No. 32 “Orthodontic Wires”, the diameter of the archwires (for example 0.016-inch nickel titanium archwires) still measures to have the same diameter after subjected to the preparation, silane treatment and hydrophilic hydrogel matrix coating described herein. More specifically, it was found that the diameter of the coated low-friction archwires were equivalent according to this Specification No. 32 since the mean of the diameter of the archwires was within 3 standard deviations of the targeted diameter (for example 0.016 inch). Since the coating thickness is insignificant, an orthodontist can select the same size of low-friction coated archwires as would be chosen for uncoated archwires.

Concerning mechanical properties, the effect of the coating on archwires does not change when comparing the coated low-friction archwire with an uncoated archwire of the same type and size. For example, the unloading force for shape-memory nickel titanium wire was tested following ANSI/ADA Specification No. 32 “Orthodontic Archwires”. The mechanical testing consisted of a three-point bend of the archwire. More specifically, each archwire was initially deflected to 3.1 mm and then unloaded with the force magnitude recorded at 3.0, 2.0, 1.0 and 0.5 mm, the testing being performed at 37° C. Upon comparing the average unloading force of the coated low-friction archwire with the average unloading force of the uncoated archwire, it was determined that the unloading force of the coated archwire in all of the recorded deflections was within three standard deviations of the uncoated wire. According to Specification No. 32, this indicates that the wires have an equivalent unloading force. Testing on stainless steel wires and nickel titanium wires not of the shape-memory type exhibited the same results.

The conclusion is that an orthodontist can use a coated low-friction archwire according to the present disclosure without being concerned whether or not the wire will apply the same force as the same size and type of uncoated wire. In other words, the coated low-friction wires of the present disclosure apply the same amount of force as uncoated archwires of the same material and size when used in an orthodontic application.

Lubricity of the wires coated according to the present disclosure was tested. Coated low-friction shape memory 0.016-inch diameter archwires and uncoated shape memory 0.016-inch diameter archwires were tested by cutting straight lengths from the respective archwires and placing them in three in-line orthodontic brackets. The archwires on the three in-line brackets were pre-soaked for 24 hours in de-ionized water at 37° C. to simulate in-mouth placement. The maximum frictional force was tested by pulling each archwire through the archwire slot of the brackets at 11.0 mm/min (0.04 inch/min) for a distance of 0.5 mm (0.02 inch). During this testing, the archwires and ligatures in the assembly were kept irrigated with 37° C. de-ionized water. The coated low-friction archwires according to the present disclosure showed a reduction of friction of over 75%. Similar testing on stainless steel wire and nickel titanium wire not of the shape-memory type exhibited substantially the same reduction in friction upon coating.

In addition, it has been determined that the coating of the present disclosure exhibits abrasion resistance. Testing was performed in which straight lengths of archwires with the low-friction coating according to the present disclosure were placed in three in-line orthodontic brackets and secured using standard ligatures and then placed in 37° C. de-ionized water. The coated wires then were abraded using a medium hardness toothbrush and toothpaste every day. At the end of eight weeks of abrading in this manner, the coated wires were tested, and it was determined that the coated archwires still exhibited a reduction in friction when compared with uncoated archwires of the same size and type.

The following Examples illustrate some of the features of archwires according to the present disclosure.

### Example 1

Three types of orthodontic archwires were tested, each made of a different metal wire. One type was stainless steel, made of stainless steel alloy, namely UNS S30400 (AISI304) of TP Orthodontics, Inc. Another type of metal wire was of nickel titanium alloy. A third type of wire was a shape-memory nickel titanium alloy. Each of the three types of wires had a diameter of 0.4064 mm.

Each type of wire had a group of wires set aside to be a control group having no coating applied to the wires. Wires not in the control group were prepared by being placed in a cleaning/passivation solution having 30 volume percent nitric acid and 70 volume percent de-ionized water for 30 minutes. Upon removal from this solution, the wires were rinsed with de-ionized water and air dried at room temperature. This provided prepared wires.

The thus prepared wires were subjected to a pre-treatment as follows. Each wire was placed in a silane coupling solution including 0.8 weight percent of N-[3-(trimethoxysilyl) propyl]-N′4-(vinylbenzyl)ethylene diamine.Cl, along with 98.28% methanol and 1.08% water. This placement continued for 15 minutes. Immediately after removal from this treatment solution, each wire was dried in an oven at 150° C. for 15 minutes. After drying and cooling, each archwire represented a prepared and treated wire.

Each such prepared and treated wire then was placed in a solution for forming a hydrophilic hydrogel matrix. This coating solution comprised a polymer blend. It included 1.28 weight percent polyvinyl pyrrolidone, 0.48 weight percent of a thermoplastic polyurethane with an ether backbone (polyether urethane), 45.03 weight percent tetrahydrofuran, 8.26% weight percent 1-methyl-2-pyrrolidone, and 45.03 weight percent of ethanol. Contact with this coating solution proceeded for five minutes. The wires then were placed in an oven at 160° C. for 30 minutes and allowed to cool so as to provide coated archwires according to the present disclosure.

These coated archwires and the control archwires were subjected to lubricity testing by using testing plates having three in-line central orthodontic brackets adhered to the plate at a distance of 2.54 mm apart. Straight lengths measuring 50 mm were cut from the straightest sections of each coated archwire and each control archwire and placed in the archwire slots of the three in-line brackets. Standard, uncoated orthodontic ligatures from TP Orthodontics, Inc. were used to ligate the archwire lengths into the slots. The wires then were placed in a 37° C. de-ionized water bath for 24 hours.

Thereafter, the frictional force between the wires and the brackets was tested by moving each wire through the archwire slots of the testing plates mounted in an MTS tensile testing device, described in greater detail in Example 3. Each wire was clamped into the pulling jaws of the MTS device and then pulled using a cross-head speed of 1 mm/min for one minute or until the friction transferred from static friction to kinetic friction. The reduction in frictional force was calculated by dividing the measured frictional force of the tested coated wire by the frictional force of an uncoated wire, subtracting this result from the number 1 and multiplying by 100. Using this equation resulted in a calculated “Reduction in Friction.”

Each type of coated metal wire experienced a reduction in friction when compared with the uncoated wire. The average reduction in friction was calculated from the test data for five coated and five uncoated wires of each type. For the stainless steel wires, the reduction in friction was 79.4%. For the nickel titanium alloy wires, the reduction in friction was 61.4%. For the shape-memory nickel titanium alloy wires, the reduction in friction was 75.5%.

### Example 2

Orthodontic archwires were coated incorporating different hydrophilic hydrogels. Stainless steel orthodontic archwires (S30400 or AISI 304 from TP Orthodontics, Inc.) were obtained, and some of these untreated archwires were set aside as a control group. Wires not in the control group were placed in a cleaning/passivation solution of 30 volume percent nitric acid, remainder de-ionized water, for 30 minutes. After removal from this solution, each wire was rinsed with de-ionized water and air dried at room temperature. Each such passivated wire was then placed in a silane coupling solution in accordance with Example 1 for 15 minutes, followed by removal and oven drying for 15 minutes at 150° C. They were allowed to cool and subjected to three different hydrogel solutions as follows to provide the hydrophilic hydrogel matrix coating.

Hydrogel Solution A was comprised of 0.99 weight percent polyvinyl pyrrolidone, 0.49 weight percent polyether urethane, 46.18 weight percent tetrahydrofuran, 6.16 weight percent 1-methyl-2-pyrrolidone, and 46.18 weight percent ethanol.

Hydrogel Solution B comprised 1.23 weight percent polyvinyl pyrrolidone, 0.49 weight percent polyether urethane, 46.07 weight percent tetrahydrofuran, 6.14 weight percent 1-methyl-2-pyrrolidone, and 46.07 weight percent ethanol.

Hydrogel Solution C comprised 1.20 weight percent polyvinyl pyrrolidone, 0.48 weight percent polyether urethane, 45.03 weight percent tetrahydrofuran, 8.26 weight percent 1-methyl-2-pyrrolidone, and 45.03 weight percent ethanol.

A group of the silane-treated wires were placed in their respective coating compositions, namely groups of five wires were coated with one of Solution A, Solution B or Solution C for five minutes. Each wire then was placed in an oven at 150° C. for 30 minutes. Testing plates, components and procedures were followed as in Example 1. At the end of a 24-hour soak in water, the frictional force of each wire moving through the archwire slots on the testing plates was measured by mounting the testing plates in the MTS tensile testing device in the same manner as described in Example 1. The calculated average reduction in friction for the five wires coated using Hydrogel Solution A and measured by the testing device was 67.8%. The calculated average reduction in friction for the five wires coated in Hydrogel Solution B was 60.4%. The average reduction in friction for the five wires coated using Hydrogel Solution C was 79.4%.

### Example 3

Hydrogel-coated archwires were subjected to abrasion testing over the course of seven weeks. The coated archwires exhibited a maximum reduction in friction of 73%, and the coated archwires that were subjected to the abrasion testing retained some reduction in friction (up to 13.4%) after seven weeks of abrasion testing.

### Preparation of Lubricious Wires

A total of 25 nickel titanium alloy 0.016 inch diameter upper standard archwires (REFLEX® archform, Part No. 992-642 TP Orthodontics, Inc.) were obtained. A total of 15 of the 25 archwires were subjected to nitric acid passivation following ASTM F86-04. The solution used was composed of 142.9 grams of 0.7 nitric acid and 357.1 grams of de-ionized water to make a 20% nitric acid solution. These wires were placed in the passivation solution at room temperature for 30 minutes, followed by immediate rinsing with de-ionized water and air drying at room temperature. Different treatment groups were organized. One treatment group was for the archwires for placement on central brackets for friction testing. Each of these treatment groups contained five straight archwire lengths. These are identified as Group A through Group E, as set out in Table I.

TABLE I

| Group | Treatment of Archwires for Central Brackets |
|---|---|
| A | Abrasion Control (no cleaning/passivation, no silane, no |
| | hydrogel coating) |
| B | Cleaning/passivation, silanated, and coated with |
| | Solution C of Example 2 |
| C | Friction Control (no cleaning/passivation, no silence, no |
| | hydrogel coating) |
| D | Cleaning/passivation, silanated, and coated with |
| | Solution C of Example 2 |
| E | Cleaning/passivation, silanated, and coated with |
| | Solution C of Example 2 |

Other treatment groups were organized for archwires for placement on lateral brackets for friction testing. Each of these treatment groups were to be contained by straight archwire lengths. These are set out in Table II as Group F through Group J.

TABLE II

| Group | Treatment or Archwires for Lateral Brackets |
|---|---|
| F | Abrasion Control (no cleaning/passivation, no silane, no |
| | hydrogel coating) |
| G | Cleaning/passivation, silanated, and coated with |
| | Solution C of Example 2 |
| H | Friction Control (no cleaning/passivation, no silence, no |
| | hydrogel coating) |
| I | Cleaning/passivation, silanated, and coated with |
| | Solution C of Example 2 |
| J | Cleaning/passivation, silanated, and coated with |
| | Solution C of Example 2 |

The wires of Groups B, D, E, G, I and J were placed in a silane solution for 15 minutes, the solution comprising 10 grams of silane having the formula: N-[3-(trimethoxysilyl)propyl]N′-4-(vinylbenzyl)ethylene diamine.Cl. Also included were 490 grams of methanol and 5 grams of de-ionized water. The wires were removed from the silane solution and dried in a 150° C. oven for 15 minutes and allowed to cool for three minutes. They then were placed in a hydrophilic hydrogel matrix solution according to Solution C of Example 2. After removal from this solution, the coated wires were placed in an oven at 150° C. for 30 minutes. The straight portion of each archwire was cut in order to provide straight lengths of wire approximately 50 mm in length, with two such straight lengths being obtained from each archwire.

### Friction Testing

A test fixture as described in Example 1 was set up using central MBT NU-EDGE® brackets of TP Orthodontics, Inc., Part No. 293-312A. These have a 0.56 mm archwire slot. Each was ligated with uncoated orange MINI-STIX™ ligatures of TP Orthodontics, Inc., Part No. 984-474 to 0.56 by 0.71 mm rectangular wire (Part No. 993-035 of TP Orthodontics) 38.1 mm in length. The brackets were ligated 2.54 mm apart from archwire slot to archwire slot on the 0.56 by 0.71 mm wire length. Three parallel lines running from the top of the testing plate surface to the bottom of its surface were drawn 8.26 mm apart. PYTHONT™ sealant resin from TP Orthodontics, Inc., Part No. 151,256A, was then placed on the line where the brackets were to be placed. On the pad of the brackets the sealant resin was added, light-cured adhesive paste was applied to the pad, and the brackets were placed on the line with the sealant resin and pressed down. The 0.56 by 0.71 mm archwire to which the brackets were ligated was lined up with the line on the testing plate. Once the brackets were correctly lined up, the adhesive was cured. These steps were repeated until five groups of three brackets were lined up for each of the testing groups. The archwire lengths for each respective group then were ligated to the appropriate brackets.

Friction testing was performed at T:0 using a Q Test I Electromechanical Testing System, MTS Systems Corp., with a 500-gram load cell. The testing plates were attached to this friction testing fixture. The ligatures, brackets and wires were then wetted with de-ionized water, after which each archwire was pulled through the three brackets at 1 mm/min for 40.75 mm, or until the peak static friction had been reached and the kinetic friction remained stable. The brackets were tested at T=0 to determine if the proper test setup had been achieved, after which the specimens were placed in a de-ionized water bath at 37° C. for 24 hours.

The soaked testing plates then were rinsed with de-ionized water and attached to the friction testing fixture. Each archwire was then pulled through the brackets at 1 mm/min for 40.75 mm or until the peak static friction had been reached and the kinetic friction remained stable. After testing at T=24 hours, the specimens were placed in a de-ionized water bath at 37° C.

### Abrasion Testing and Wire Parameters

Abrasion simulation was performed on selected specimens. Each of these specimens was brushed for two minutes with a toothbrush having medium-stiffness bristles, with a toothpaste-water slurry at a 2:1 ratio. Each of these wires subjected to abrasion simulation underwent the same friction pull testing as the rest of the specimens. Both the friction testing and the abrasion simulation for the selected abrasion specimens were repeated at T=0, 0.143, 1, 2, 3, 4, 5, 6 and 7 weeks. The wires subjected to abrasion simulation had the corresponding brackets brushed with a medium bristle toothbrush for two minutes five times a week.

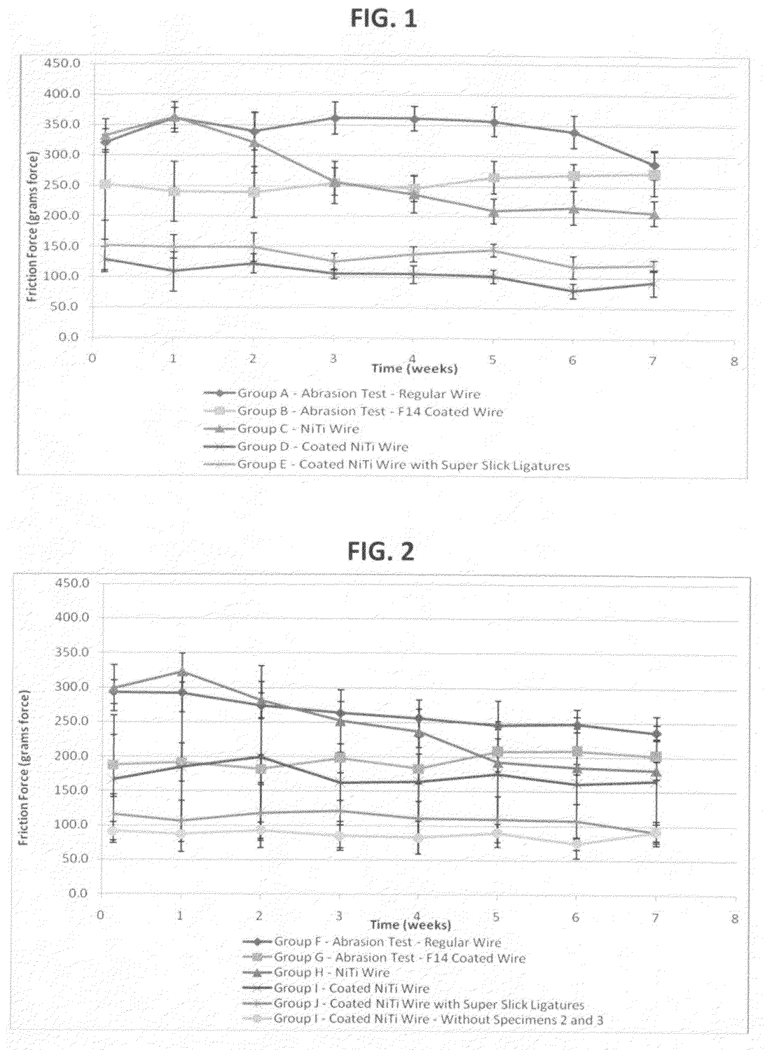

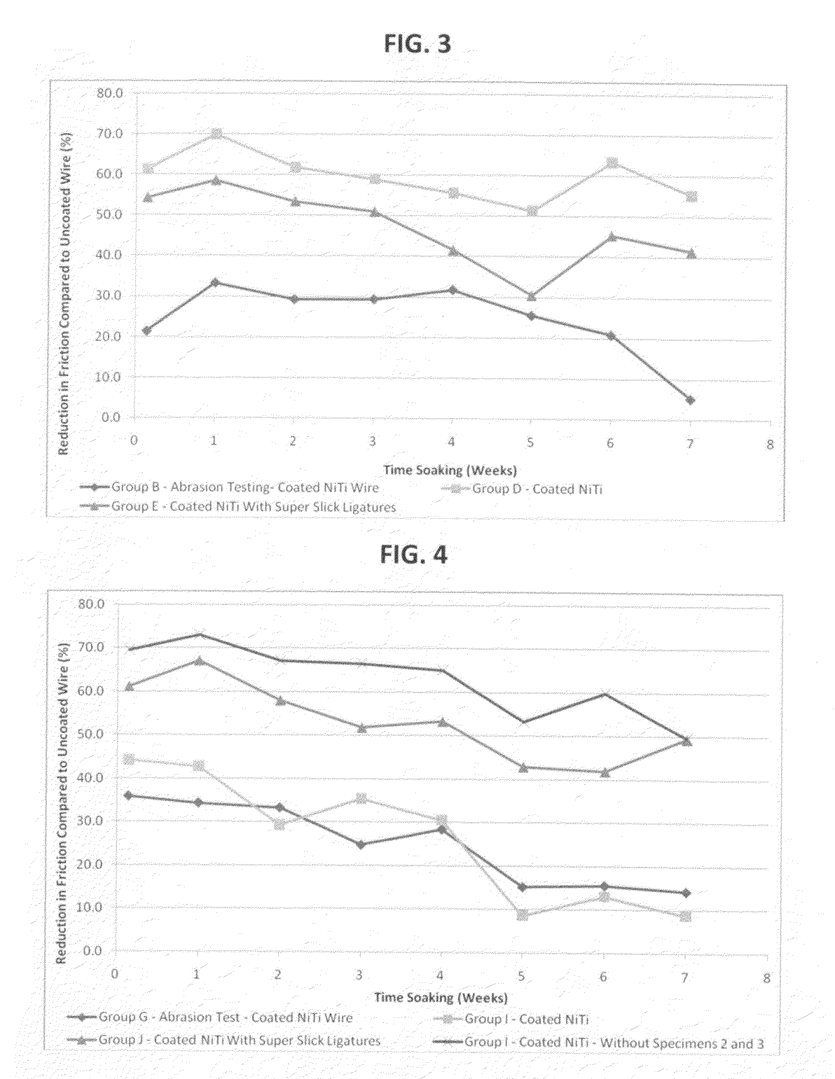

Archwires diameters were measured, with the uncoated archwires measuring 0.00159±0.0001 inch, while the diameters of the coated wire measured the same. This indicates that the silane treatment and hydrogel matrix coating did not significantly increase the diameter of the archwires. This further indicates that the thickness of this coating is less than 0.0001 inch. The static frictional force exerted on the wires collected at each data point at each testing point is shown in FIG. 1 (for central bracket use) and FIG. 2 (for lateral bracket use), while the reduction in friction for the non-controlled groups is shown in FIG. 3 (central) and FIG. 4 (lateral).

Friction readings for two of the test specimens for the coated archwires on lateral brackets were significantly higher than the other specimens in the group, likely due to misaligned brackets for these two specimens with this outlying frictional force data. Therefore, as acknowledged in FIG. 2 and FIG. 4, an additional testing group was added with the removal of the outlying specimens. The reduction in frictional force was determined using the “Reduction in Friction” equation of Example 1. The wires exhibiting the lowest overall frictional force were Group D (Table I) for the wires on central brackets and Group I (without the two outlyers) (Table II) for the wires on lateral brackets. For both of these Groups, the frictional force remained relatively stable over the course of the study and decreased with time for Group D. Group D and Group I (without the two outlyers) also showed the greatest percent reduction in friction initially and over time.

More specifically, Group D had an initial reduction of friction of 61.4% at 24 hours, a reduction of friction of 55.4% at the end of seven weeks, and a maximum reduction of friction of 69.9% after one week of soaking in water. Group I (without the two outlyers) had an initial reduction in friction of 69.5% at 24 hours (0.143 week), a reduction of 49.6% at the end of seven weeks, and a maximum reduction of friction of 73% after one week of soaking in water.

The abrasion testing of the coated nickel titanium alloy archwires, those of Group B and Group G, showed good abrasion resistance. Group B showed an initial reduction in friction of 24.1% after 24 hours, a reduction in friction of 5.2% at the end of seven weeks, and a maximum reduction of friction of 33.4% after one week of abrasion testing. Group G showed an initial reduction in friction of 36.0% after 24 hours, and a reduction in friction under uncoated wire of 14.3% at the end of seven weeks of abrasion testing. These data indicate that the coating has enough wear resistance to last at least seven weeks in an abrasive environment.

This testing indicates that nickel titanium archwires treated and coated as described herein achieve a maximum reduction in friction compared to uncoated wires of 73.0% after one week (on the central brackets) and a maximum reduction in friction of 55.4% after seven weeks (on the lateral brackets). The maximum reduction in friction of the abraded specimens was 14.3% after seven weeks of abrasion testing (on lateral) with a peak reduction in friction of 36.0% after 24 hours (on lateral).

### Example 4

A total of 17 lengths of 355.6 mm long 0.441 mm diameter stainless steel archwires (TP Orthodontics, Inc., Part No. 992-185) were cut to provide 51 lengths of 114.3 mm each. Each length was subjected to nitric acid passivation to provide a new clean oxide layer that is primarily CrO. The passivation bath used followed ASTM F86-04 and was composed of 223.9 grams of 0.7% nitric acid and 300 grams of de-ionized water to make a 30% nitric acid solution. The wires were placed in the solution for 30 minutes at room temperature, followed by rinsing with de-ionized water to remove the acid solution, and air drying at room temperature was allowed to proceed.

A silane treatment solution was prepared in accordance with Example 3, and wire emersion proceeded for 15 minutes, followed by drying in a 115° C. oven for 15 minutes. Wires were then placed in one of four hydrophilic hydrogel polymer blend solutions shown in Table III.

TABLE III

| | | |
|---|---|---|
| Mass | Chemical/Material | % by mass |

Hydrogel Solution D:

| | | |
|---|---|---|
| 8.0 g | Polyvinyl pyrrolidine (PVP) | 1.20 |
| 3.2 g | Estane 5714 polyether urethane | 0.48 |
| 300.0 g | Tetrahydrofuran (THF) | 45.03 |
| 55.0 g | 1-Methyl-2-pyrrolidone (NMP) | 8.26 |
| 300.0 g | Ethanol | 45.03 |

Hydrogel Solution E:

| | | |
|---|---|---|
| 8.0 g | Polyvinyl pyrrolidine (PVP) | 1.10 |
| 3.2 g | Estane 5714 polyether urethane | 1.79 |
| 300.0 g | Tetrahydrofuran (THF) | 44.78 |
| 50.0 g | 1-Methyl-2-pyrrolidone (NMP) | 7.46 |
| 300.0 g | Ethanol | 44.78 |

Hydrogel Solution F:

| | | |
|---|---|---|
| 12.0 g | Polyvinyl pyrrolidine (PVP) | 1.78 |
| 12.2 g | Estane 5714 polyether urethane | 1.78 |
| 300.0 g | Tetrahydrofuran (THF) | 44.51 |
| 50.0 g | 1-Methyl-2-pyrrolidone (NMP) | 7.42 |
| 300.0 g | Ethanol | 44.51 |

Hydrogel Solution G:

| | | |
|---|---|---|
| 18.0 g | Polyvinyl pyrrolidine (PVP) | 2.65 |
| 12.2 g | Estane 5714 polyether urethane | 1.76 |
| 300.0 g | Tetrahydrofuran (THF) | 44.12 |
| 50.0 g | 1-Methyl-2-pyrrolidone (NMP) | 7.35 |
| 300.0 g | Ethanol | 44.12 |

Groups of wires were arranged according to the treatment and coating applied to each. For the central wires, these groupings were identified as Group AA through Group EE, and these are reported in Table IV.

TABLE IV

| Group | Treatment |
|---|---|
| AA | Control (no cleaning/passivation, no silane, no hydrogel |
| | coating) |
| BB | Cleaning/passivation, silanated, and coated with Hydrogel |
| | Solution D |
| CC | Cleaning/passivation, silanated, and coated with Hydrogel |
| | Solution E |
| DD | Cleaning/passivation, silanated, and coated with Hydrogel |
| | Solution F |
| EE | Cleaning/passivation, silanated, and coated with Hydrogel |
| | Solution G |

For the archwires to be placed on laterals, the wires were arranged according to Group FF through Group JJ. These are reported in Table V.

TABLE V

| Group | Treatment |
|---|---|
| FF | Control (no cleaning/passivation, no silane, no hydrogel |
| | coating) |
| GG | Cleaning/passivation, silanated, and coated with Hydrogel |
| | Solution D |
| HH | Cleaning/passivation, silanated, and coated with Hydrogel |
| | Solution E |
| II | Cleaning/passivation, silanated, and coated with Hydrogel |
| | Solution F |
| JJ | Cleaning/passivation, silanated, and coated with Hydrogel |
| | Solution G |

Each of these coating groups contained five wires, and upon removal from the respective coating solutions for all but the control wires, the wires were placed in an oven at 150° C. for 30 minutes, testing plates were used and friction testing was performed in accordance with Example 3 above. Abrasion testing proceeded generally as in accordance with Example 3, except the abrasion simulation and friction testing was repeated at T=1, 2, 3, 4, 5, 6, 7, 8 and 9 weeks.

The diameter of the wire was not significantly affected by coating the wire with any of these treatments and coatings. See Table VI.

TABLE VI
Diameter of Wire, mm (in)

| Specimen | Uncoated | Solution D | Solution E | Solution F | Solution G |
|---|---|---|---|---|---|
| 1 | 0.4039 | 0.4039 | 0.4064 | 0.4064 | 0.4064 |
| 2 | 0.4039 | 0.4039 | 0.4064 | 0.4064 | 0.4064 |
| 3 | 0.4039 | 0.4039 | 0.4039 | 0.4039 | 0.4064 |
| 4 | 0.4013 | 0.4039 | 0.4039 | 0.4039 | 0.4039 |
| 5 | 0.4039 | 0.4039 | 0.4039 | 0.4064 | 0.4064 |
| 6 | 0.4039 | 0.4039 | 0.4064 | 0.4064 | 0.4039 |
| 7 | 0.4039 | 0.4039 | 0.4064 | 0.4064 | 0.4039 |
| 8 | 0.4013 | 0.4039 | 0.4039 | 0.4039 | 0.4064 |
| 9 | 0.4013 | 0.4039 | 0.4064 | 0.4039 | 0.4039 |
| 10 | 0.4013 | 0.4039 | 0.4064 | 0.4064 | 0.4039 |
| Average | 0.4039 | 0.4039 | 0.4064 | 0.4064 | 0.4064 |
| | (0.0159) | (0.0159) | (0.0160) | (0.0160) | (0.0160) |
| Std. Dev. | 0.0025 | 0.0000 | 0.0025 | 0.0025 | 0.0025 |
| | (0.0001) | (0.0000) | (0.0001) | (0.0001) | (0.0001) |

For the uncoated wire, the average diameter of the wire was 0.4039±0.0025 mm (0.0159±0.0001 in) which is slightly smaller the target diameter of 0.4064 mm (0.0160 in). The same is true for the wires coated with Solution D, the wire had a diameter of 0.4039±0.0025 mm (0.0159±0.0000 in). The wires coated with Solutions E, F and G all had a diameter of 0.4064±0.0025 mm (0.0160±0.0001). All of the coated wires could therefore be used in standard brackets without having to take into account the thickness of the coating on the wire.

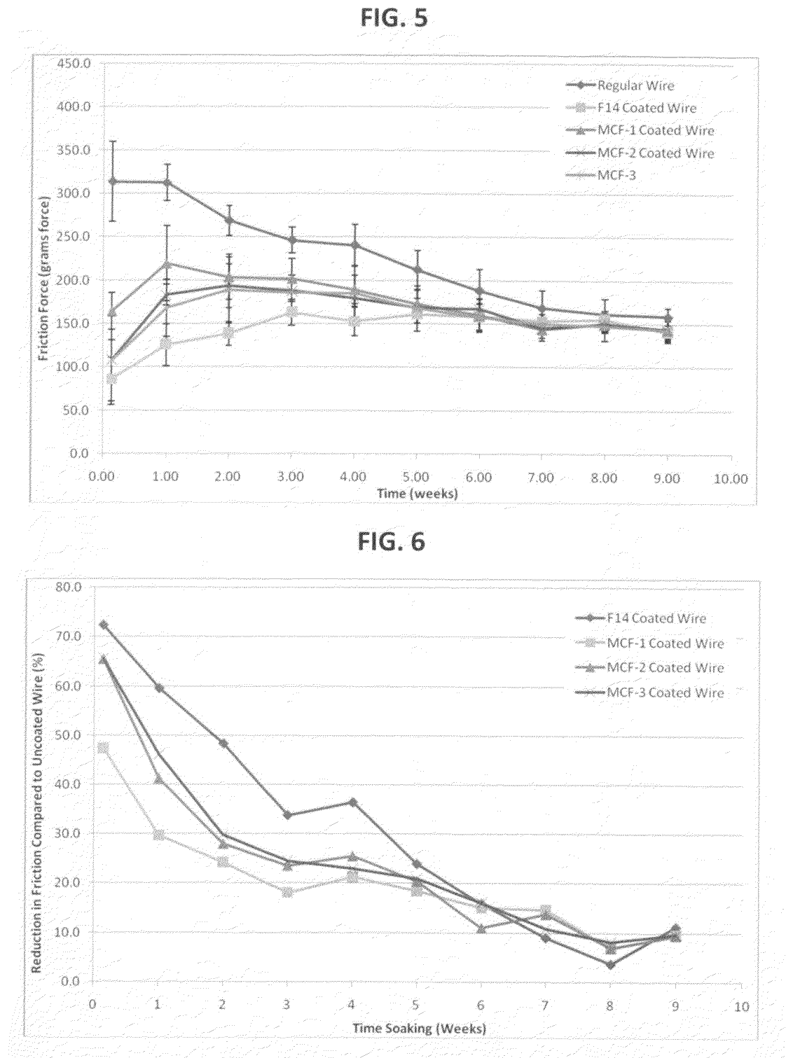

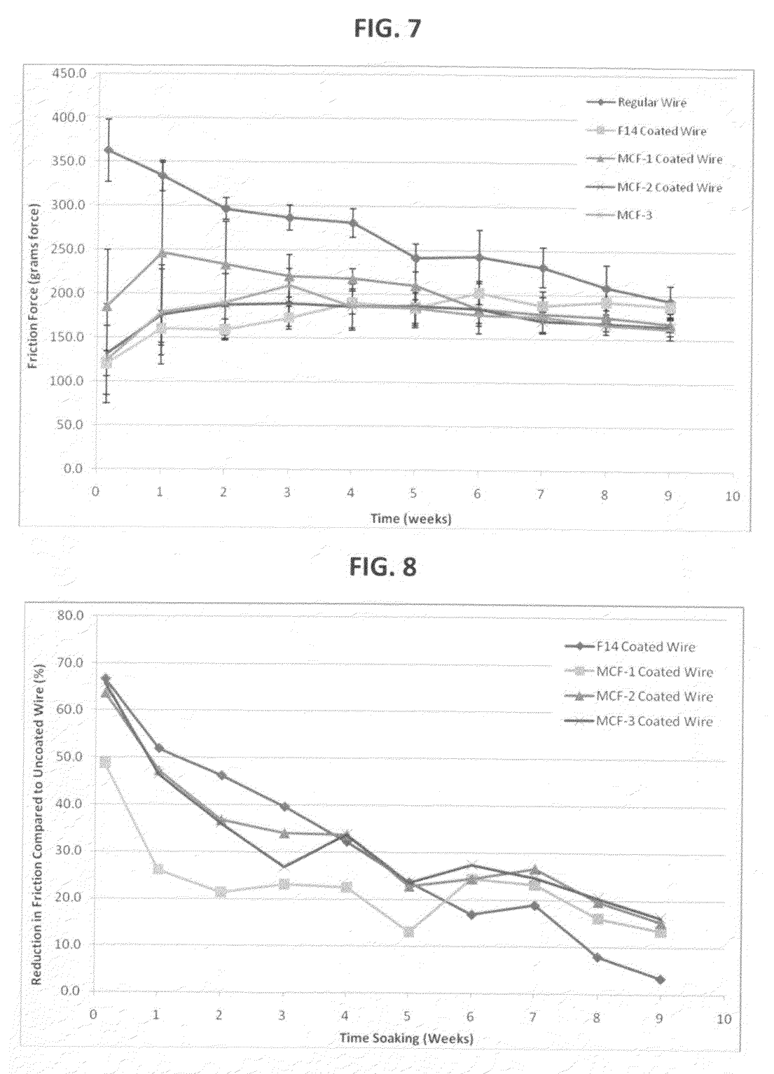

The static frictional force exerted on the wires collected at each data point at each testing point is given in FIG. 5 for the wires on the central brackets and in FIG. 7 for the wires on the lateral brackets. The following is observed from these data. The wires with hydrogel Solution D coating on the central brackets (Group BB) had an average frictional force at T=24 hours of 120.7±19.5 grams. The corresponding coated archwires on lateral brackets (Group GG) had an average frictional force, at T=24 hours of 86.3±24.0 grams. Looking at the data for initial reduction in frictional force same was at 66.7% for Group BB and 72.5% for Group GG. Since the greatest tooth movement during an orthodontic procedure occurs during the first few weeks of treatment, it is most important for the friction to be lowest during the first few weeks. By having these low-frictional forces, these wires exhibited the greatest reduction in friction over the first three weeks. For the Group BB wires, the reduction in friction was 66.7% to 39.6%, and for Group GG, the reduction in friction was 72.5% to 33.9%.

Observation of the coated archwires at the end of the abrasion testing using light microscopy showed that the coating on all of the wires was abraded away on the exposed portions of the wire. The coating was not abraded away in areas of the archwire protected from the abrading of the toothbrush and on the opposite side of the archwire. Since none of the coatings lasted on the specimens until the end of 9 weeks, then 9 weeks is the life of the coatings.

### Example 5

Tests were conducted that unexpectedly indicated that the combination of coated archwires and coated ligatures did not reduce the frictional force more than the combination of archwires coated in the same manner but used with uncoated ligatures. A total of 48 uncoated MINI-STIX™ (TP Orthodontics, Inc.) ligatures were obtained, with 20 of these being left uncoated. Four of these ligatures were coated with Hydromer METAFASIX® (TP Orthodontics, Inc.), eight were coated with F12 R3METAFASIX® hydrogel solution, and eight were coated with Hydrogel Solution D of Example 4. These ligatures were coated by placing same in their respective hydrogel solutions for two minutes and then being dried in an oven for 20 minutes at 150° C.

A total of 60 stainless steel archwires of 0.016 inch diameter and 14-inch lengths were cut into 5.5 inch lengths, and 20 of these were set aside for the uncoated wire groups. The remaining wire lengths were immersed in a saline solution for five minutes and then dried in an oven for 15 minutes at 150° C. The saline-treated wires were immersed in their respective hydrogel solutions for five minutes and then dried in an oven for 30 minutes at 150° C.

The resulting specimens were tested by pulling the wire through the test plate brackets at 5 mm/min (0.2 inch/min) for a distance of 5 mm using the Q Test-1 electromechanical Testing Frame using a 500-gram load cell. The force in grams and the distance pulled were recorded at T=0, T=24 hours and at T=1, 2, 3, 4, 5 and 6 weeks. The specimens were irrigated with water prior to testing, and after the test at T=0, the specimens were placed in de-ionized water at 37° C. between tests.

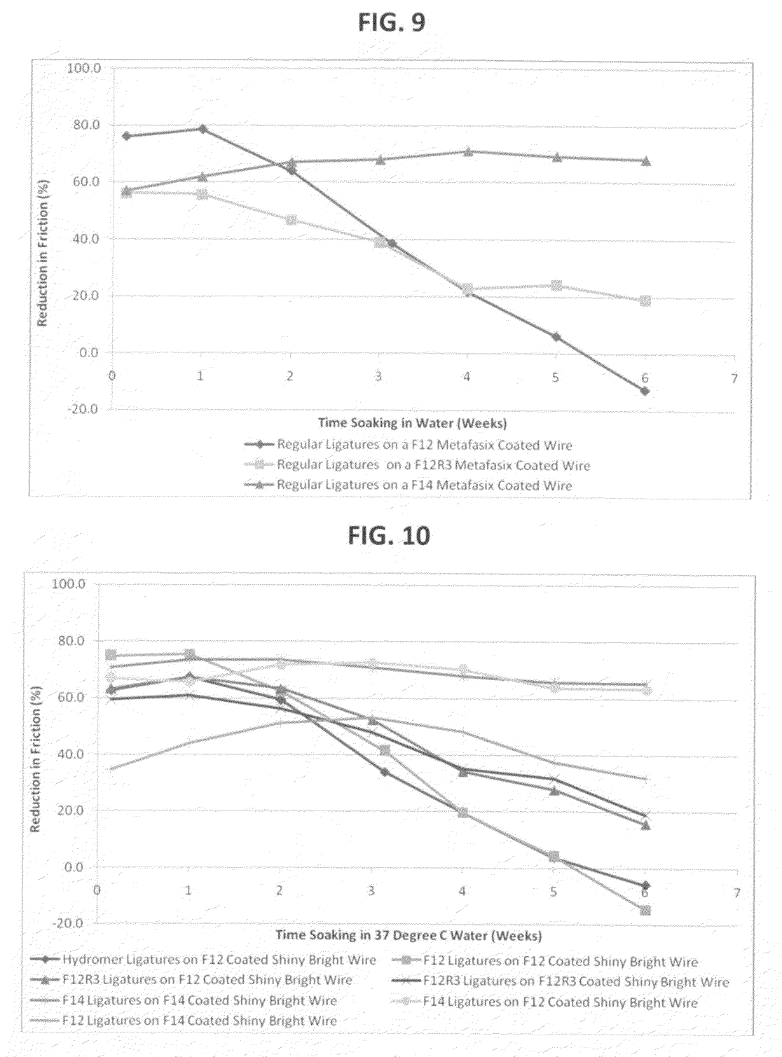

Peak frictional force was noted and averaged for each wire group at each time point. The brackets with uncoated wires were used as the control group. Reduction in friction was calculated as noted in Example 1. Different controls were used depending on whether the brackets were centrals or laterals. These reduction in friction data were then plotted and are reported in FIG. 9 for central brackets with uncoated elastic ligatures and hydrogel-coated 0.016 inch diameter stainless steel wire. The FIG. 10 data report on reduction in frictional force on central brackets from hydrogel-coated elastic ligatures and hydrogel-coated 0.016 inch diameter stainless steel wires.

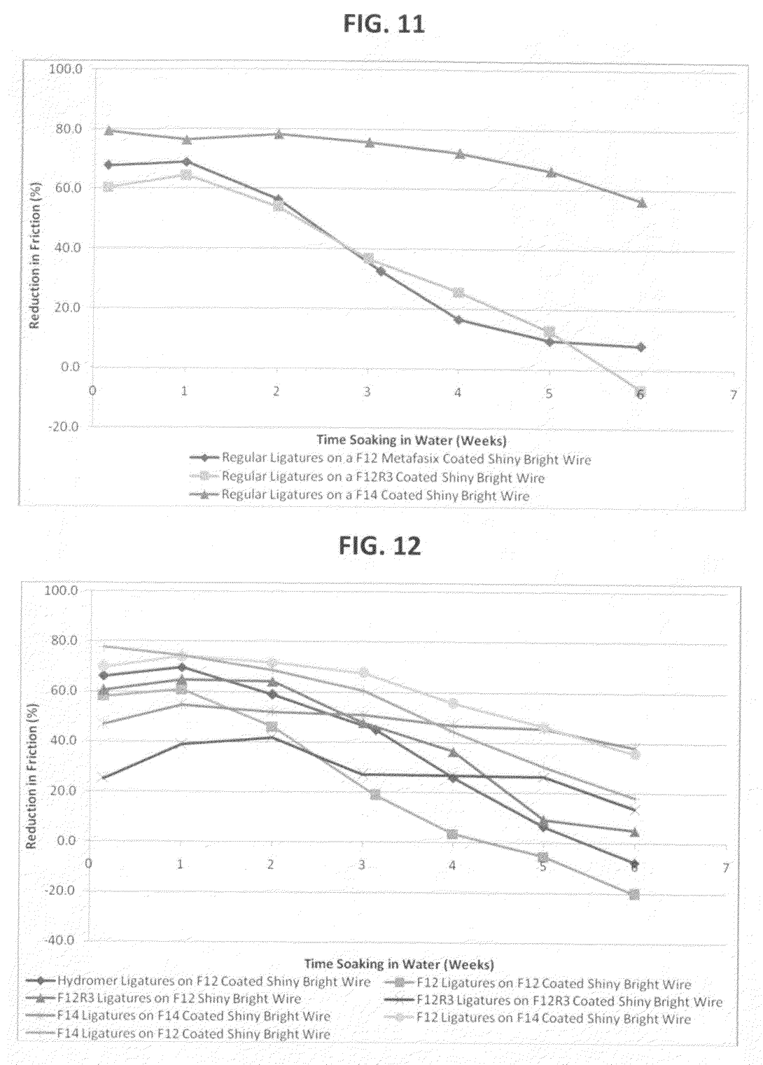

The FIG. 11 data concern reduction in frictional force on lateral brackets from uncoated elastic ligatures and hydrogel-coated 0.016 inch diameter stainless steel wire. FIG. 12 reports data concerning reduction in frictional force on lateral brackets from hydrogel-coated elastic ligatures and hydrogel-coated 0.016 inch diameter stainless steel wires. The reduction in frictional force is a comparison of how much the peak frictional force is reduced from an uncoated wire with standard uncoated ligatures. Since the reduction in frictional force was used instead of force per se, the different groups across different wires, bracket types and ligatures could be compared.

The combination of a stainless steel with the Hydrogel Solution D coating on stainless steel wire with uncoated ligatures showed the greatest reduction in frictional force. For example for the centrals, there was approximately a 56% reduction in frictional force over uncoated stainless steel wire with uncoated ligatures at the end of the study, as seen in FIG. 9. For the hydrogel-coated wire and the hydrogel-coated ligatures on upper centrals, FIG. 10 shows that the wires coated with Hydrogel Solution D and Hydrogel Solution D coated ligatures had the greatest reduction in friction remaining at the end of the study, this being 38.2%, while the Hydrogel Solution D coated wires with other hydrogel-coated ligatures were a close second with 35.7% reduction in friction when compared with uncoated ligatures on uncoated stainless steel wire.

The same trend is illustrated in FIG. 11 and FIG. 12. The combination of Hydrogel Solution D coated stainless steel wire and uncoated ligatures on upper laterals had the greatest reduction in friction remaining after six weeks (at 68.3% reduction in friction) compared with uncoated stainless steel wires with uncoated ligatures. The hydrogel-coated archwires that had the greatest initial reduction in friction (T=24 hours) did not always end the testing with the highest reduction in friction, as noted in FIG. 9 and FIG. 12.

There was no benefit seen to using hydrogel-coated archwires with hydrogel-coated ligatures. Hydrogel Solution D coated archwires on centrals gave a reduction in friction of 79.4% after 24 hours and 56.6% after six weeks compared with the combination of Hydrogel Solution D stainless steel archwires and hydrogel Solution D coated ligatures, which gave a reduction in friction of 46.9% after 24 hours and 38.2% after six weeks, as seen in FIG. 9 and FIG. 10. Similar results are exhibited for coated stainless steel archwires and coated archwires with coated ligatures on lateral brackets.

It will be understood that the embodiments of the present invention which have been described are illustrative of some of the applications of the principles of the present invention. Numerous modifications may be made by those skilled in the art without departing from the true spirit and scope of the invention, including those combinations of features that are individually disclosed or claimed herein.

The invention is hereby claimed as follows:

1. A metal orthodontic appliance comprising: a metal wire, said metal wire has a hydrophilic hydrogel polymer coating, and said thus coated wire becomes lubricious when wetted.

2. The appliance of claim 1, wherein the hydrophilic hydrogel polymer coating is a cured polymer matrix formed from a polymer blend composition including a hydrophilic hydrogel polymer, a matrix polymer, and at least one solvent.

3. The appliance of claim 2, wherein said hydrophilic hydrogel polymer is a polyvinyl pyrrolidone.

4. The appliance of claim 2, wherein said matrix polymer is a polyurethane.

5. The appliance of claim 4, wherein said polyurethane is a polyether polyurethane.

6. The appliance of claim 4, wherein said polyurethane has a Shore hardness between about 65 A and about 95 A.

7. The appliance of claim 2, wherein said polymer blend composition includes between 0.5 and 3 weight percent of said hydrophilic hydrogel polymer, between about 0.25 and about 3 weight percent of said matrix polymer, between about 5 and about 10 weight percent of a co-solvent, and at least about 80 weight percent of another solvent.

8. The appliance of claim 7, wherein said co-solvent is NMP and said other solvent is a combination of tetrahydrofuran and a low molecular weight alcohol.

9. The appliance of claim 1, wherein said metal wire is a silane-treated wire, with said hydrophilic hydrogel polymer coating being secured to the silane-treated metal wire.

10. The appliance of claim 1, wherein said metal wire is a passivated wire that is silane treated, with said hydrophilic hydrogel polymer coating being secured to the passivated and silane-treated metal wire.

11. The appliance of claim 1, wherein the appliance is an orthodontic archwire.

12. The appliance of claim 1, wherein said coating has a diameter of less than about 0.0001 inch.

13. A metal orthodontic appliance comprising: a metal archwire having a lubricious polymer matrix coating whereby the lubricious coating decreases the coefficient of friction of the appliance when wetted, said lubricious coating being cured from a polymer blend composition comprising a polyvinyl pyrrolidone, a polyurethane and a solvent, and said polymer matrix coating is a matrix of said polyvinyl pyrrolidone and polyurethane, said matrix having a thickness of not more than about 0.0001 inch.

14. The appliance of claim 13, wherein the polyurethane is a polyether polyurethane having a Shore hardness between about 65 and about 95 A.

15. The appliance of claim 13, wherein said metal wire is a passivated wire that is silane treated, with said lubricious polymer matrix coating being secured to the passivated and silane-treated metal wire.

16. The appliance of claim 13, wherein the coefficient of friction decrease reduces friction between said archwire and an orthodontic bracket by a least about 60%.

17. A method of making a metal orthodontic appliance comprising:
forming an appliance with a metal surface;
treating the metal surface with a coupling agent to provide a treated surface of the metal; and
coating the treated surface of the metal with a hydrophilic polymer blend so that the coefficient of friction is substantially decreased over that of the metal surface prior to said coating when the metal orthodontic appliance is wetted.

18. The method of claim 17, further including preparing the surface of the metal appliance prior to said treating and coating.

19. The method of claim 18, wherein said preparing comprises passivating the surface of the metal.

20. The method of claim 17, wherein said treating comprises contacting the metal surface with a silane solution and drying same.

21. The method of claim 17, wherein said coating comprises contacting the treated surface of the metal with a hydrophilic polymer composition of polyvinyl pyrrolidone, polyether polyurethane and at least one solvent.
